(19) United States
(12) Patent Application Publication
(10) Pub. No.: US 2020/0001499 A1
(43) Pub. Date: Jan. 2, 2020

(54) COMPOSITE HOUSING OF CERAMIC AND PLASTIC AND METHOD FOR MANUFACTURING THE SAME

(71) Applicants: SHENZHEN FUTAIHONG PRECISION INDUSTRY CO., LTD., Shenzhen (CN); FIH (HONG KONG) LIMITED, Kowloon (HK)

(72) Inventors: JING-HAI ZHENG, Shenzhen (CN); YU-TSAI WANG, New Taipei (TW)

(21) Appl. No.: 16/137,569

(22) Filed: Sep. 21, 2018

(30) Foreign Application Priority Data
Jun. 29, 2018 (CN) 201810703841.7

(51) Int. Cl. B28B 11/24; B29C 45/14

(52) U.S. Cl. CPC B28B 11/243; B29K 2709/02; B29C 45/14336

(57) ABSTRACT

A housing comprising a ceramic material to which a plastic layer is firmly bonded includes a substrate, a plastic member, and a porous layer. The porous layer is pitted and formed between the substrate and the plastic member by coating and sintering a porous ceramic slurry on a surface of the ceramic substrate. The present disclosure also provides a method for manufacturing the housing.

### FIELD

The disclosure generally relates to composite housings.

### BACKGROUND

Ceramic housings are used in electronic devices such as mobile phones and tablet computers. However, it is difficult for ceramic member to combine with plastic because of its high density. In order to produce a ceramic member combined with plastic, the ceramic member is usually soaked with chemical agents.

Therefore, there is room for improvement within the art.

### BRIEF DESCRIPTION OF THE DRAWINGS

Many aspects of the present disclosure can be better understood with reference to the drawings. The components in the drawings are not necessarily drawn to scale, the emphasis instead being placed upon clearly illustrating the principles of the disclosure. Moreover, in the drawings, like reference numerals designate corresponding parts throughout the views.

FIG. 1 is a cross-sectional view of part of a housing in accordance with an embodiment of the present disclosure.

FIG. 2 is a cross-sectional view of the part in accordance with another embodiment of the present disclosure.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The term “coupled” is defined as coupled, whether directly or indirectly through intervening components, and is not necessarily limited to physical connections. The connection can be such that the objects are permanently coupled or releasably coupled. The term “comprising” when utilized, means “including, but not necessarily limited to”; it specifically indicates open-ended inclusion or membership in the so-described combination, group, series, and the like.

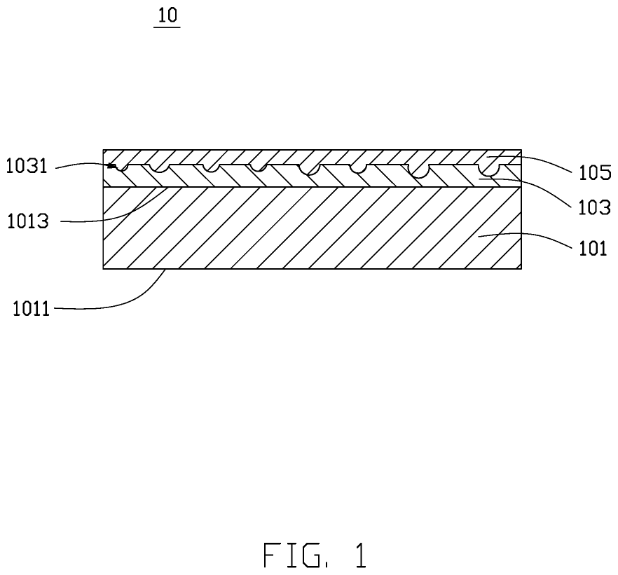

FIG. 1 shows a housing 10 of an embodiment of the present disclosure. The housing 10 can be used for an electronic device such as a mobile phone or a tablet computer.

The housing 10 can include a substrate 101, a porous layer 103, and a plastic member 105.

The substrate 101 can include an outer surface 1011 and an inner surface 1013 opposing the outer surface 1011. The outer surface 1011 serves as an external surface of the housing 10. In this embodiment, the substrate 101 is made of ceramic material. For example, the substrate 101 is made of a ceramic powder and a sintering agent in a mass ratio of about 7:3.

The porous layer 103 is formed on the inner surface 1013 of the substrate 101. The porous layer 103 improves the bonding between the substrate 101 and the plastic member 105. The porous layer 103 has a thickness of about 0.1˜0.15 mm.

The porous layer 103 can be formed by coating a porous ceramic slurry on the inner surface 1013 of the substrate 101. In this embodiment, the porous ceramic slurry is prepared by mixing the ceramic powder, a porous agent, and the sintering agent in a mass ratio of about 5:3:2. In this embodiment, the porous ceramic slurry contains silica.

In this embodiment, the porous ceramic slurry is uniformly coated on the inner surface 1013, and sintered at an oven temperature of 500° C. for one hour to form the porous layer 103. Specifically, the porous agent becomes effectively pitted, forming a plurality of pores 1031 in the porous layer 103. Each of the pores 1031 has a pore diameter of about 10˜30 μm and a pore depth of about 30˜10 μm.

The plastic member 105 can be formed on the porous layer 103 by injection molding method. Specifically, each of the pores 1031 is partially or completely infilled by the plastic member 105, so that the plastic member 105 is firmly bonded to the porous layer 103. The plastic member 105 can be made of a nano injection molded plastic selected from a group consisting of polyamide, polyphenylene sulfide, polybutylene terephthalate, polycarbonate, and polyvinyl chloride.

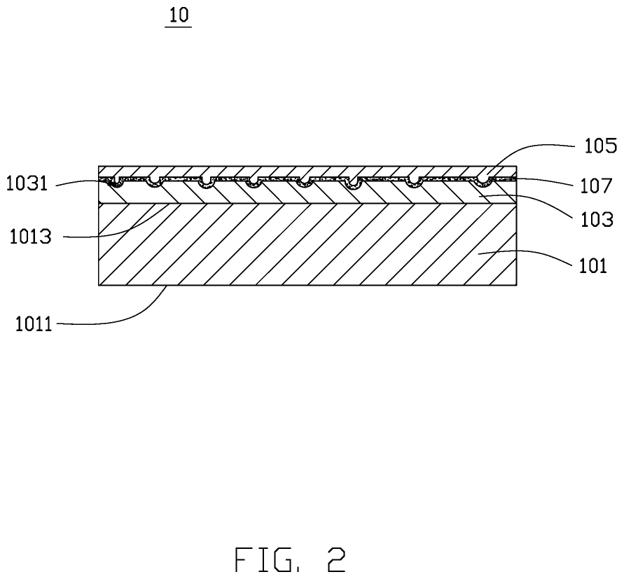

In FIG. 2, in another embodiment, the housing 10 can further include a bonding layer 107. The bonding layer 107 is formed between the porous layer 103 and the plastic member 105 and improves the bonding between the porous layer 103 and the plastic member 105.

The bonding layer 107 can be formed by surface-treating the porous layer 103. In the present embodiment, the bonding layer 107 is formed by coating a silane coupling agent on the surface of the porous layer 103. Specifically, bottom part of each of the pores 1031 is infilled by the bonding layer 107, and other part of each of the pores 1031 is infilled by the plastic member 105, so that the plastic member 105 is firmly formed on the surface of the porous layer 103. Since the porous layer 103 contains silica, the silane coupling agent modifies the surface of the porous layer 103 to tightly bond the porous layer 103 to the plastic member 105.

The present disclosure also provides a method for manufacturing the housing 10 of FIG. 1, including at least the steps of:

preparing a substrate 101;

preparing a porous ceramic slurry;

coating the porous ceramic slurry on a surface of the substrate 101 to form a porous layer 103; and

forming a plastic member 105 on the surface of the porous layer 103.

Specifically, the substrate 101 is made of ceramic material, and includes an outer surface 1011 and an inner surface 1013 opposing the outer surface 1011. The outer surface 1011 serves as an external surface of the housing 10.

The substrate 101 can be prepared by the following steps: mixing a ceramic powder and a sintering agent in a mass ratio of about 7:3, grinding for 24 hours, drying and sieving to obtain a uniformly mixed powder. The uniformly mixed powder is dry-pressed and pre-sintered at an oven temperature of about 400˜600° C. for about 1 hour to obtain the substrate 101. The substrate 101 after pre-sintering is in a semi-cured state with low strength, which is advantageous for subsequent processing.

The substrate 101 can be cut and ground by computer numerical control machine or/and carving machine cooperating to obtain a preliminary structure of the housing 10.

The porous ceramic slurry can be prepared by the following steps: mixing the ceramic powder, a porous agent, and the sintering agent in a mass ratio of about 5:3:2 by ultrasonic vibration, baking at about 50° C. for about 30 minutes to obtain the porous ceramic slurry. The porous ceramic slurry contains silica.

The porous layer 103 can be obtained through the following steps: coating the ceramic slurry uniformly on the inner surface 1013, sintering at an oven temperature of about 500° C. for about 1 hour to form the porous layer 103. Specifically, during maximum heat, the porous agent can be removed to form a plurality of pores 1031 in the porous layer 103. Each of the pores 1031 has a pore diameter of about 10˜30 μm and a pore depth of about 30˜10 μm.

In addition, the substrate 101 coated with the porous layer 103 can be further sintered at an oven temperature of about 1200˜1500° C. to remove the sintering agent, this increases density of the substrate 101, so as to increase the strength of the substrate 101.

The plastic member 105 can be formed on the surface of the porous layer 103 through the following steps: placing the substrate 101 coated with the porous layer 103 in a mold, injecting molten plastic material into the mold so as to cover the porous layer 103, infilling the pores 1031 and hardening the molten plastic material to obtain the plastic member 105. The molten plastic material can be selected from a group consisting of polyamide, polyphenylene sulfide, polybutylene terephthalate, polycarbonate, and polyvinyl chloride.

Furthermore, a bonding layer 107 can be formed between the porous layer 103 and the plastic member 105 to improve the bonding between the porous layer 103 and the plastic member 105. The bonding layer 107 can be formed by surface-treating the porous layer 103.

The bonding layer 107 can be formed through the following steps: coating a silane coupling agent on a surface of the porous layer 103 to partially infill the pores 1031. The pores 1301 that are not so infilled are infilled by the plastic member 105. Since the porous layer 103 contains silica, the silane coupling agent modifies the surface of the porous layer 103 to tightly bond the porous layer 103 to the plastic member 105.

A pull-off test was performed on the housing 10, and results showed that the bonding strength between the porous layer 103 and the plastic member 105 was greater than 10 MPa.

A shear test was performed on the housing 10, and results showed that the shear force of the housing was greater than 25 MPa.

The porous ceramic slurry is used to facilitate the formation of the porous layer 103 in any region of the substrate 101 according to actual needs, simplifies the preparation process, and reduces the preparation costs. In addition, the method for manufacturing the housing 10 provided by the present disclosure is environmentally friendly, no chemical agents are used.

It is to be understood, however, that even through numerous characteristics and advantages of the present disclosure have been set forth in the foregoing description, together with details of assembly and function, the disclosure is illustrative only, and changes may be made in details, especially in the matters of shape, size, and arrangement of parts within the principles of the disclosure to the full extent indicated by the broad general meaning of the terms in which the appended claims are expressed.

What is claimed is:

1. A housing, comprising a substrate, a plastic member and a porous layer, wherein the porous layer is:
located between the substrate and the plastic member; and
formed by coating a porous ceramic slurry on a surface of the substrate.

2. The housing as claimed in claim 1, wherein the porous ceramic slurry is made of a ceramic powder, a porous agent, and a sintering agent in a mass ratio of about 5:3:2.

3. The housing as claimed in claim 1, wherein the porous layer has a thickness of about 0.1˜0.5 mm.

4. The housing as claimed in claim 1, wherein the porous layer is formed with a plurality of pores, and each of the pores is partially or completely infilled by portions of the plastic member.

5. The housing as claimed in claim 4, wherein each of the pores has a pore diameter of about 10˜30 μm and a pore depth of about 30˜10 μm.

6. The housing as claimed in claim 4, wherein the housing further comprises a bonding layer formed between the porous layer and the plastic member, and each of the pores is infilled by the bonding layer and portions of the plastic member.

7. The housing as claimed in claim 6, wherein the bonding layer is formed by coating a silane coupling agent on a surface of the porous layer.

8. The housing as claimed in claim 1, wherein the substrate is made of a ceramic powder and a sintering agent in a mass ratio of about 7:3.

9. The housing as claimed in claim 1, wherein the plastic member is made of a nano injection molded plastic selected from a group consisting of polyamide, polyphenylene sulfide, polybutylene terephthalate, polycarbonate, and polyvinyl chloride.

10. A method for manufacturing a housing, comprising steps of:
preparing a substrate;
preparing a porous ceramic slurry;
coating the porous ceramic slurry on a surface of the substrate to form a porous layer; and
forming a plastic member on a surface of the porous layer.

11. The method as claimed in claim 10, wherein the porous layer is formed with a plurality of pores, and each of the pores has a pore diameter of about 10˜30 μm and a pore depth of about 30˜10 μm.

12. The method as claimed in claim 11, wherein the method further comprises a step of forming a bonding layer on the surface of the porous layer before forming the plastic member on the surface of the porous layer.

13. The method as claimed in claim 12, wherein bottom part of each of the pores is infilled by the bonding layer, and other part of each of the pores is infilled by the plastic member.

14. The method as claimed in claim 10, wherein the porous ceramic slurry is made of a ceramic powder, a porous agent, and a sintering agent in a mass ratio of about 5:3:2.

15. The method as claimed in claim 10, wherein the porous layer has a thickness of about 0.1˜0.5 mm.

16. The method as claimed in claim 12, wherein the bonding layer is formed by coating a silane coupling agent on the surface of the porous layer.

17. The method as claimed in claim 10, wherein the substrate is prepared by the following steps: mixing a ceramic powder and a sintering agent in a certain ratio, grinding, drying, and sieving to obtain a uniformly mixed powder; dry-pressing the uniformly mixed powder and pre-sintering at an oven temperature of about 400˜600° C. to obtain the substrate.

18. The method as claimed in claim 17, wherein the ceramic powder and the sintering agent are mixed in a mass ratio of about 7:3.

19. The method as claimed in claim 10, wherein the plastic member is made of a nano injection molded plastic selected from a group consisting of polyamide, polyphenylene sulfide, polybutylene terephthalate, polycarbonate, and polyvinyl chloride.

20. The method as claimed in claim 10, wherein the method further comprising a step of sintering the substrate coated with the porous layer at an oven temperature of about 1200˜1500° C. to remove the sintering agent.
